(19) United States
(12) Patent Application Publication
(10) Pub. No.: US 2012/0189753 A1
(43) Pub. Date: Jul. 26, 2012

(54) APPLIANCE FOR PREPARING A CHOCOLATE-BASED BEVERAGE

(75) Inventors: Fabien Ludovic Agon, Le Bouveret (CH); Alexa Perrin, Pully (CH); Alexandre Perentes, Lausanne (CH)

(73) Assignee: NESTEC S.A., Vevey (CH)

(21) Appl. No.: 13/499,119

(22) PCT Filed: Sep. 29, 2010
(86) PCT No.: PCT/EP2010/064414

§ 371 Date: Mar. 29, 2012

(30) Foreign Application Priority Data
Sep. 29, 2009 (EP) 09171608.4
Nov. 3, 2009 (EP) 09174839.2

(51) Int. Cl. A47J 31/44; A23G 1/56; A23C 9/156; A23F 5/00; B01F 3/12; A23L 2/56

(52) U.S. Cl. 426/584; 426/442; 426/431; 426/594; 366/151.1; 99/323.3

(57) ABSTRACT

A process for preparing a beverage comprises: providing a liquid carrier; supplying a flavouring ingredient to the liquid carrier; optionally heating the liquid carrier; and agitating the liquid carrier to promote dissolution and/or dispersion of the flavouring ingredient therein. The flavouring ingredient is supplied in the form of a self-sustaining body (2) to the liquid carrier, the self-sustaining body (2) having at least one surface (3) from which the flavouring ingredient is dissolved and/or dispersed into the liquid carrier. The liquid carrier is agitated in a controlled manner to circulate on this surface so as to achieve a controlled dissolution and/or dispersion of the flavouring ingredient into the liquid carrier.

### FIELD OF THE INVENTION

The present invention relates to an appliance for preparing a beverage with a liquid carrier, e.g. milk and/or water, and a flavouring ingredient, such as a cacao-based ingredient.

### BACKGROUND ART

Various methods are known to prepare chocolate-based beverages. Generally speaking, one may distinguish two types of such chocolate beverages. On the one hand, there are the so-called “ready-to-drink” chocolate beverages which concern the chocolate beverages that are prepared industrially and supplied to the consumer in a directly consumable form. On the other hand, there are the instant chocolate beverages that are supplied to the consumer in the form of particulate chocolate flavouring to be mixed with water and/or milk by the consumer before consumption.

For example, U.S. Pat. No. 6,290,997 and U.S. Pat. No. 6,838,110 disclose instant beverages in the form of coffee-, tea- or cocoa-containing particulate ingredient. The beverage is prepared by a user by mixing such powder with water and/or milk and stirring the mixture for a couple of seconds. In the latter document, it is inter-alia mentioned that, as an inferior embodiment, it is contemplated to supply to the consumer tablets or other solid forms of agglomerate powder ingredient.

U.S. Pat. No. 6,796,705 discloses a mug with a motorised whisk powered by a battery. A first liquid such as milk may be poured into the mug and aerated by activating the motorised whisk. Thereafter, a second liquid can be poured into the aerated milk, the aerated milk floating on top. The second liquid that is poured into the mug may be hot coffee or hot chocolate. The preparation of the second liquid itself is not addressed.

U.S. Pat. No. 6,318,247 relates to an appliance having a vessel with a heating element and a motorised mixing element for preparing hot milk mixed with a flavouring agent such as cocoa or chocolate for producing an amount of froth on top of the beverage in the vessel.

Further frothing tanks having a heater and motorised stirrer are disclosed, for example, in EP1827188 and WO 2008/142154.

U.S. Pat. No. 4,435,084 discloses a cup with a motor driven blade assembly to stir a beverage and a sweetener and/or a creamer.

EP 1 238 608 discloses a beverage applicator having a support member with a beverage material applied thereto such as coffee, milk and/or sugar. A user may hold and immerse the applicator in hot water and manually stir the applicator to form a beverage.

A problem with the preparation of chocolate beverages by mixing cocoa-based powder material with milk or water lies in the incomplete dissolution and/or dispersion of the powder material in the milk. The problem is even worse when chocolate material is used to flavour milk or water as a layer of cocoa fat forms on top of the liquid.

### SUMMARY OF THE INVENTION

It is therefore an object of the invention to alleviate the disadvantages of the prior art by proposing a system for preparing flavoured beverages, in particular chocolate beverages.

This object is generally achieved by a process for preparing a beverage that comprises: providing a liquid carrier; supplying a flavouring ingredient to the liquid carrier; optionally heating the liquid carrier; and agitating the liquid carrier to promote dissolution and/or dispersion of the flavouring ingredient therein.

In accordance with the invention, the flavouring ingredient is supplied in the form of a self-sustaining body to the liquid carrier. The self-sustaining body has at least one surface from which the flavouring ingredient is dissolved and/or dispersed into the liquid carrier. The liquid carrier is agitated in a controlled manner to circulate on said at least one surface so as to achieve a controlled dissolution and/or dispersion of the flavouring ingredient into the liquid carrier.

The self-sustaining body may have a volume that is greater than 2 or 3 cm³, in particular a volume of at least 5 or 10 cm³ such as at least 15 to 20 cm³. Such a self-sustaining body would thus not include one or a plurality of loose powder particles, granules or small chips or fragments of flavouring ingredient.

For example, the liquid will be agitated by a motorised impeller actuated at a constant or a predetermined variable speed adjusted to the characteristics of the carrier liquid and the ingredient body. A controller may be used to control the motorised impeller.

Hence, by applying the process of the invention, uncontrolled addition of flavouring ingredient to the carrier liquid causing precipitation of the flavouring ingredient is inhibited. Furthermore, the incorporation of flavouring ingredients with a low miscibility in the liquid carrier, in particular chocolate e.g. cast bodies of chocolate in water, can be achieved satisfactorily, e.g. by full or part emulsification.

Hence, a predominantly or entirely hydrophobic self-sustaining ingredient may be incorporated into a predominantly or entirely hydrophilic liquid carrier, or a predominantly or entirely hydrophilic self-sustaining ingredient may be incorporated into a predominantly or entirely hydrophobic liquid carrier. In this manner the formation of separated phases may be inhibited. The resulting beverage may be a dispersion of the hydrophobic phase in the hydrophilic phase and/or vice versa.

As opposed to a random chaotic incorporation of the ingredient into the liquid carrier, the controlled, in particular, slow controlled dissolution and/or dispersion by automatic agitation in line with a predetermined agitation inhibits unwanted phase separation in the resulting beverage.

The liquid carrier can be water, milk and/or coffee based. The flavouring ingredient may comprise instant coffee, chocolate, cocoa, sugar or honey. For example a self-sustaining body of chocolate (meltable and/or cast cocoa-based solid body) is placed in agitated hot water and/or milk to form hot chocolate in the form of a beverage having an optimal chocolate distribution in the liquid carrier without any precipitation of chocolate or significant phase separation in the beverage. Alternatively, such a body of chocolate may be used in hot or heated coffee to form a mocha coffee. A sweetener such as sugar and/or honey may be incorporated into a milk-based or other liquid carrier in the same manner.

For instance, chocolate, such as white chocolate, milk chocolate or dark chocolate, e.g. chocolate containing cocoa butter or equivalent fat in an amount of more than 15 or 20% in particular in the range of 25 or 30 to 55 or 70%, is not an instant beverage ingredient. Chocolate and like ingredients have a relatively slow dissolution and/or dispersion rate in heated liquid and can be quite tricky to incorporate properly into such a liquid. When not incorporated in a controlled manner, chocolate tends to form a layer of fat on top of the liquid with which it is supposed to be mixed. The present invention provides a reliable and simple manner to solve this problem by controlling the incorporation automatically via a motorised impeller and usually a heater, both adjusted to the characteristics of chocolate and liquid carrier to optimise the mixing between the carrier and the chocolate ingredient. In such a way a proper emulsification of the chocolate ingredient with the liquid carrier can be achieved, overcoming the prior art problems.

More generally, the term “chocolate” used herein includes in particular dark, milk or white chocolate. The chocolate may comprise sugar, milk derived components and fat and solids from cocoa sources in differing proportions where the total fat content is greater than 25% or 28% by weight of the chocolate. The term chocolate is not limited to materials which may legally be described as chocolate in various countries of the world. In addition, the chocolate may comprise any product or substance having rheological characteristics similar or substantially comparable to those of chocolate having a fat content greater than 25% by weight. Such a product may include chocolate substitutes containing direct cocoa butter replacements, stearines, coconut oil, palm oil, butter or any mixture thereof; chocolate analogues with cocoa butter replaced by a non tempering fat; chocolate products where the sugar has been replaced partially or completely by for example other nutritive carbohydrate sweeteners, or ‘Caramac™’ sold by Nestlé comprising non-cocoa butter fats, sugar and milk. In addition, chocolate products containing water in an amount of less than 50 or 60%, in particular up to 40 or 45%, such as up to 30 or 35%, for instance in the range of 5 or 10 to 20 or 25%, are also included, for example water-containing chocolate compositions that are described in EP 1 759 591.

To reduce the risk of precipitation, the flavouring ingredient can be dissolved and/or dispersed into the liquid carrier at a substantially uniform and sufficiently slow rate from over the entire ingredient dissolution and/or dispersion surface. Hence, the dissolution and/or dispersion surface will be evenly worn by supplying the flavouring ingredient into the liquid carrier and no area of this surface will supply an excessive amount of ingredient leading to precipitation thereof.

The flavouring ingredient may be dissolved and/or dispersed into the liquid carrier from the body's surface at a substantially constant rate over a predominant period of time of the dissolution and/or dispersion. If and when the self-sustaining body is allowed to be entirely mixed with the liquid carrier, the structure of the body may collapse towards the end. However, a convenient tapered shape and/or permanent support structure for the body may inhibit or even prevent such a collapse.

In a preferred embodiment of the invention, the beverage preparation process is carried out in the form of a batch in a tank by dissolving and/or dispersing the flavouring ingredient into the liquid carrier that is contained in such tank. The batch typically corresponds to a portion of beverage, e.g. a drinking cup or mug, such as 0.03 to 0.4 l or 0.05 to 0.2 l.

The tank is typically associated with a means for delivering heat into the liquid carrier in a heat delivery zone, such as a heated tank wall contacting the liquid carrier and/or a hot vapour delivery outlet in the liquid carrier. Details of a tank with a heated bottom are disclosed in EP 1 827 188 and in WO 2008/142154; details of a tank with a steam heating are disclosed in EP 08 163 423.0 and in EP 08 163 427.1. The content of these documents are hereby incorporated by reference.

The combination of the principles of these prior art disclosures with the present invention provides the option of aerating or forming foam in the tank, in particular by frothing an appropriate liquid carrier such as milk. The aeration or foaming may be carried out before, during and/or after the dissolution and/or dispersion of the flavouring ingredient into the liquid carrier.

The self-sustaining body is preferably held in the liquid carrier and spaced apart from the heat delivery zone to inhibit heat-generated non-dissolved and non-dispersed supply of flavouring ingredient from the self-sustaining body into the liquid carrier. This can be of particular relevance when a meltable self-sustaining ingredient body like chocolate is used.

A vortex may be formed in the liquid carrier by controlled agitation of the liquid carrier, in particular by means of a rotating impeller such as a stirrer associated with the tank, and driving the liquid carrier therein. Examples of such configurations are disclosed in the abovementioned EP 1 827 188, WO 2008/142154, EP 08 163 423.0 and in EP 08 163 427.1 hereby incorporated by way of reference. Hence, the liquid carrier may be driven in a general circular or loop flow. It is also contemplated to subject the liquid carrier to other types of flows, such as a linear flow, in particular in a more or less straight line. The flow of liquid carrier to which the self-sustaining ingredient body is exposed, may be in a loop or open-ended. The flow may be laminar or turbulent.

The self-sustaining body typically has a main surface from which the flavouring ingredient is predominantly dissolved and/or dispersed into the liquid carrier (the “main dissolution and/or dispersion surface”). This surface is so located in the agitated liquid carrier to be exposed substantially everywhere thereto at a generally uniform relative velocity. Hence, the surface will be generally uniformly worn by dissolution and/or dispersion of the flavouring ingredient therefrom.

The invention also relates to a process for preparing a chocolate beverage. The process comprises:
providing a liquid carrier, such as milk and/or water, in a tank;
supplying chocolate, in particular a self-sustaining body of chocolate, into the liquid carrier;
heating the liquid carrier; and
agitating the liquid carrier to mix the chocolate and the liquid carrier.

In accordance with the invention, the tank is associated with a motorised impeller controlled by a control unit for controllably agitating, in particular constantly and/or uniformly, the liquid carrier in the tank to mix substantially homogeneously the chocolate in the liquid carrier.

This process may of course incorporate any of the features described above or incorporate any combination of these features.

With such a process, the agitation caused by the impeller, typically a rotary stirrer or whisk, can be adjusted to the liquid volume, chocolate quantity and the configuration of the tank to produce a properly dissolved and/or dispersed ingredient in the liquid carrier while preventing the formation of the usual layer of chocolate fat at the top of the liquid. In particular, such a method permits the preparation of traditional undistorted water chocolate drink with a smooth texture.

Another aspect of the invention relates to a beverage preparation device for carrying out a process as described above. The device comprises: a tank for containing a liquid carrier; an optional heating means for supplying heat into said liquid carrier in the tank; a motorised impeller, such as a stirrer, for imparting a controlled agitation to this liquid carrier. Such device features are disclosed in the abovementioned EP 1 827 188, WO 2008/142154, EP 08 163 423.0 and in EP 08 163 427.1 incorporated by way of reference.

Furthermore, the device of the invention comprises a support means for supporting and positioning a self-sustaining body of flavouring ingredient in such liquid carrier contained in the tank. Such a self-sustaining body has at least one surface from which this flavouring ingredient is dissolved and/or dispersed into said liquid carrier during this beverage preparation process. The motorised impeller and the support means are so located in the tank that, during use, said liquid carrier is agitated by the impeller in a controlled manner to circulate on said at least one surface of said self-sustaining body to achieve a controlled dissolution and/or dispersion of said flavouring ingredient into said liquid carrier.

The velocity of the liquid carrier passing on the dissolution and/or dispersion surface of the self-sustaining body should be aligned to the dissolution and/or dispersion rate

The tank can be associated with a means for delivering heat into the liquid carrier in a heat delivery zone, such as a heated tank wall (e.g. as disclosed in EP 1 827 188 and WO 2008/142154) and/or a hot vapour delivery outlet into the tank (e.g. as disclosed in EP 08 163 423.0 and in EP 08 163 427.1). The support means are arranged so that the self-sustaining body is held in the liquid carrier and spaced apart from the heat delivery zone during the beverage preparation process.

The impeller and the support means may be so arranged in the tank that the self-supporting body is held at a distance from the impeller to inhibit non-dissolved and non-dispersed supply of flavouring ingredient from the self-sustaining body into the liquid carrier during said process.

The tank may have a general cylindrical or frusto-conical shape extending upright about a central axis of revolution, the motorised impeller being located off-axis in the tank and the support means being arranged to support and position said self-sustaining body diameterally opposite the impeller. The support means are in particular arranged to support the self-sustaining body with a main dissolving and/or dispersing surface that faces the impeller.

By providing an off-centred impeller, the liquid carrier that is in the process of being loaded with the flavouring ingredient is better homogenised which increases the total amount of flavouring that can be incorporated by dispersion and/or dissolution into the liquid carrier without precipitation. The mechanism of homogenisation of the agitated liquid carrier by an appropriate geometry and configuration of the tank and impeller, is discussed in greater details in EP 1 827 188 which is hereby integrated by reference.

The support means can be arranged to support this self-sustaining body with a main surface thereof from which the flavouring ingredient is predominantly dissolved and/or dispersed into the liquid carrier, such main surface being arched and extending around the impeller, e.g. form at least an angular portion of a ring-like element.

The self-sustaining body may have a main surface from which the flavouring ingredient is predominantly dissolved and/or dispersed into the liquid carrier. This main surface is so located in the agitated liquid carrier to be exposed substantially everywhere thereto at a generally uniform relative velocity.

### BRIEF DESCRIPTION OF THE DRAWINGS

The invention will now be described with reference to the schematic drawings, wherein:

FIG. 1 shows part a device for carrying out a beverage preparation process according to the invention;

FIG. 2 illustrates a support arrangement for supporting and positioning a self-sustaining ingredient body for a device according to the invention;

FIG. 3 shows the support arrangement of FIG. 2 in combination with a self-sustaining ingredient body; and

FIGS. 4 and 5 illustrate another device for carrying out a beverage preparation process according to the invention.

### DETAILED DESCRIPTION

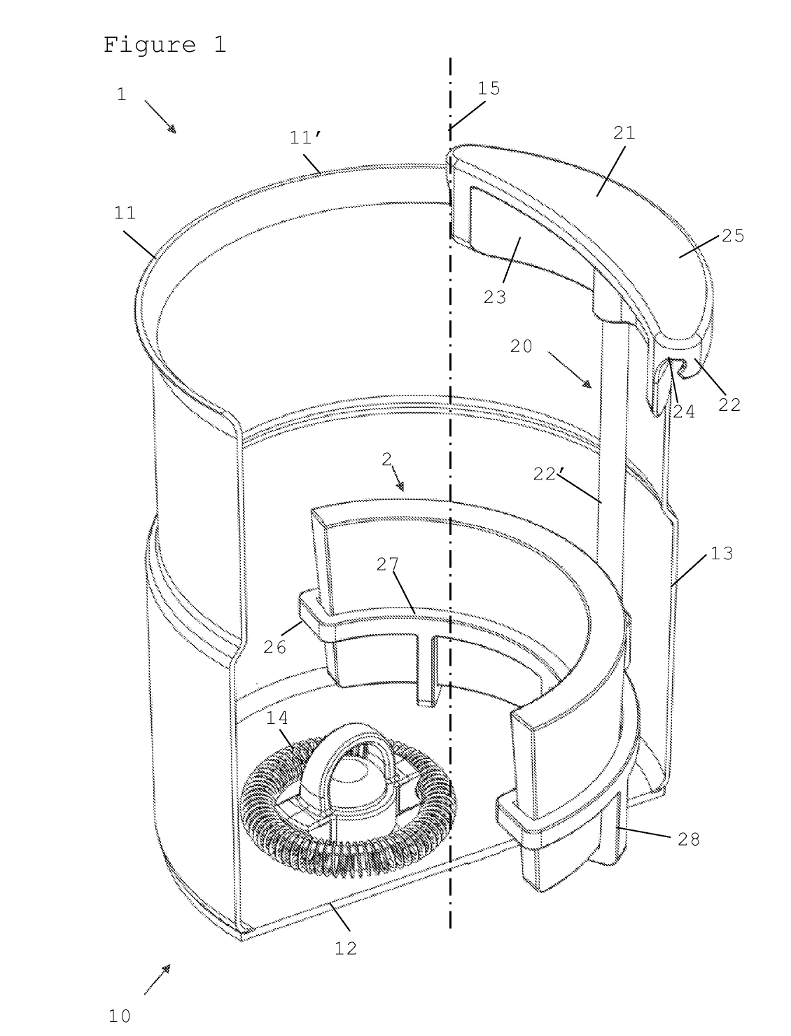

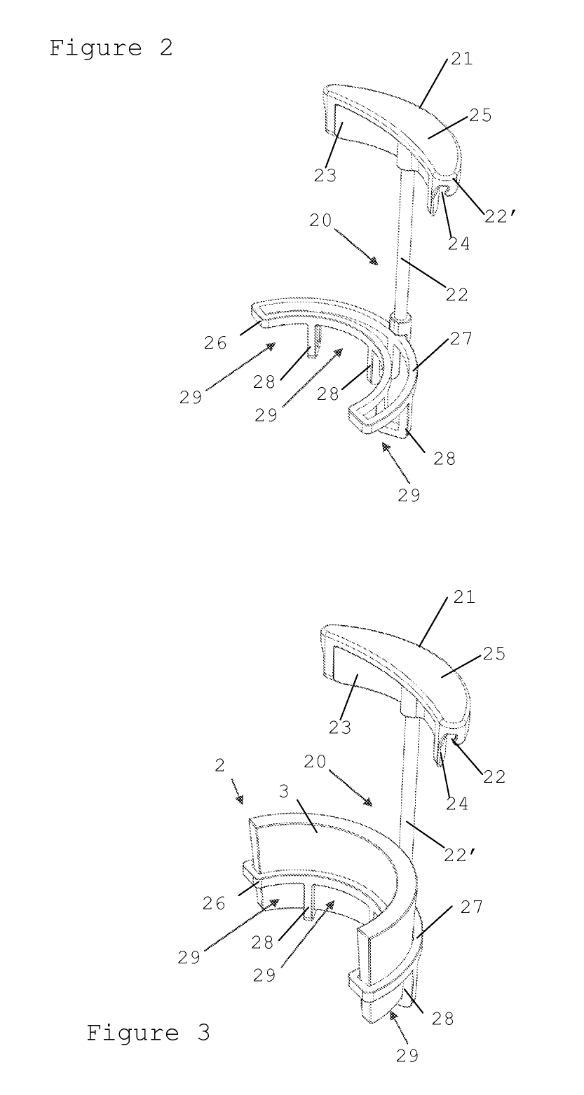

FIG. 1 shows, in perspective view, part of a device 1 for carrying out the beverage preparation process according to the invention. Device 1 has a frothing jug 10 and a support element 20 for a self-sustaining body 2 of flavouring ingredient. In FIGS. 2 and 3, support element 20 is shown separately, FIG. 3 illustrating body 2 held in element 20.

The exemplary frothing jug 10 shown in FIG. 1 has a generally cylindrical tank 11 for containing a carrier liquid (not shown). Tank 11 has a bottom 12 and sidewall 13. Tank 11 is associated with a resistive heater (not shown), e.g. a thick film heater, applied against the downwardly oriented face of bottom 12 and with a stirrer 14 cooperating with an electric motor (not shown) located underneath bottom 12. Stirrer 14 is driven through bottom 12 by the electric motor via a magnetic coupling arrangement. Further details of jugs having such a structure are disclosed in EP 1 827 188 and WO 2008/142154 that are hereby incorporated by way of reference. As an alternative, the resistive bottom heater may be replaced by a hot vapour heater the details of which can be found in EP 08 163 423.0 or in EP 08 163 427.1 hereby incorporated by way of reference.

Support element 20 has a fastening element 21 for propering fixing element 20 in tank 11. Fastening element 21 has a downwardly projecting outer wall 22 that delimits with a parallel inner wall 23 a groove 24 matching upper rim 11′ of tank 11. Walls 22 and 23 are secured together via fastening platform 25 and are resiliently configured so as to squeeze rim 11′ and safely secure element 20 in tank 11.

Platform 25 covers only a small part of the month of tank 11. Hence, the user can monitor and access the inner part of tank 11 during operation. In a variation, such a platform may cover the entire or substantially the entire mouth of the tank to avoid projections of liquid outside the tank. It is possible to make such a platform lid of transparent material so as to give visual access inside the tank during normal operation.

Via a connecting part, e.g. in the form of an upright rod 22′, fastening element 21 holds ingredient basket 26. Basket 26 has a rim part 27 generally shaped as a horizontal half-ring and a series of U-shaped suspenders 28 extending down from mouth 27. Basket may include more or fewer suspenders, say from 1 to 5 or 10 suspenders, in particular 2 to 4 or, as illustrated, 3 suspenders. Rim part 27 and suspenders 28 are arranged to firmly hold self-sustaining ingredient body 2 in tank 11 and delimit large openings 29 for exposing body 2 to the carrier liquid (not shown) through openings 29 during the beverage preparation process. Openings 29 may form at least 80, 90, 95 or 98% of the surface, in particular inner surface, of the basket 26. The outer surface (or rear surface) of basket 26 may also have such openings or be devoid of openings. However, dissolution and/or dispersion may predominantly take place adjacent the inner side of basket 26.

Self-sustaining body 2 has at least one surface, in this embodiment an arched inner surface 3, from which the flavouring ingredient is dissolved and/or dispersed into the liquid carrier during the process.

More generally, self-sustaining body 2 may have a larger surface that is generally aligned to the path of the flow of liquid carrier circulating on the body. Hence, the body's surface that is generally tangential to the flow of liquid, may be maximised to maximise the surface that is preferentially going to be worn by the passage of the liquid carrier. Typically, the body can have a generally plate-like shape with a larger ingredient supply surface positioned generally tangentially to the flow of liquid. If the liquid is circulated in a loop, as in the configuration shown in the appended Figures, body 2 may be curved or arched to follow the flow of the liquid carrier. In the particular embodiment of the invention illustrated in the appended Figures, self-sustaining body 2 is generally plate-shaped and arched, e.g. generally semi-circularly and slightly tapered to generally match the path of the circulating liquid for an optimal dissolution and/or dispersion of the ingredient from body 2.

The motorised stirrer 14 and support element 20 are so located in tank 11 that, during use, the liquid carrier is agitated by stirrer 14 in a controlled manner to circulate on the body's dissolution and/or dispersion surface 3 such as to achieve a controlled dissolution and/or dispersion of the flavouring ingredient into said liquid carrier. Stirrer 14 and support element 20 are so positioned or can be so positioned in tank 11 that body 2 is held at a distance form stirrer 14 during at least substantially the entire dissolving and/or dispersing process. Hence non-dissolved and non dispersed supply of flavouring ingredient from body 2 is prevented from being supplied into the liquid by mechanical action of stirrer 14 on body 2 which in turn would lead to uncontrolled dissolution and/or dispersion.

Tank 11 shown in FIG. 1 has a general cylindrical shape extending upright about a central axis 15 of revolution. Motorised stirrer 14 is located off-axis in tank 11 to cause an improved mixing of the liquid. Support element 20 is arranged to support and position body 2 diameterally opposite the impeller and therearound. The support element 20 is in particular arranged to support body 2 with its main dissolving and/or dispersing surface 3 that faces stirrer 14.

In this manner, a vortex formed in the carrier liquid by the rotation of stirrer 14 will have a centre of rotation that is off-axis in tank 11 with its taller surface extending over body 2.

In particular, by adjusting the inclination of surface 3 of body 2 to the particular configuration of tank 11 with stirrer 14 and the speed of rotation of stirrer 14, surface 3 can be exposed substantially everywhere thereto at a generally uniform relative velocity of the rotating liquid in tank 11. It is of course also possible to increase the velocity of the carrier liquid on the upper part of body 2, in which case body 2 will be worn not only in its thickness but also in its height by the circulating liquid carrier capturing the dissolving and/or dispersing ingredient as it passes on the body 2.

In a preferred embodiment, self-sustaining body 2 is made of chocolate in particular dark chocolate and the liquid carrier is water and/or milk.

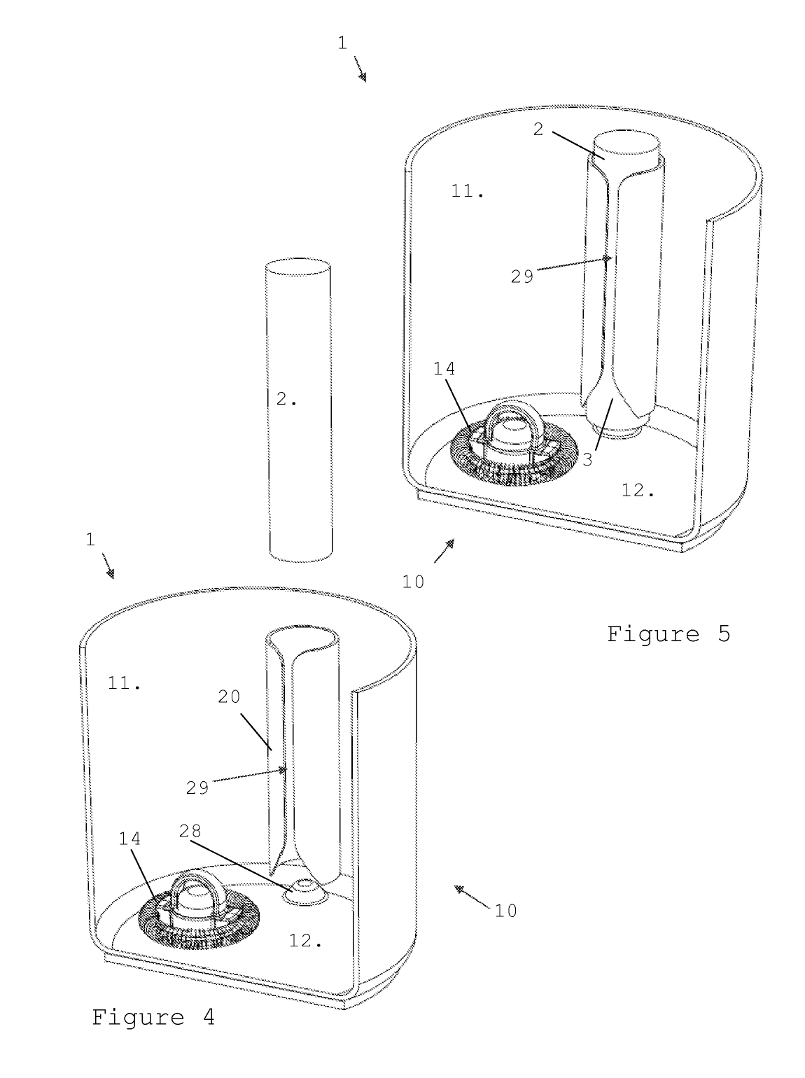

FIGS. 4 and 5, in which the same numeric references generally designate the same elements, discloses another embodiment according to the invention.

Beverage preparation device 1 may include a support member 20 fixed to device tank 11. Such support member 20 may be integral or mechanically connected to tank 11.

In this particular embodiment, support member 20 is generally tubular with a longitudinally extending opening 29.

Support member 20 is arranged to position a self-sustaining cylindrical ingredient body 2, e.g. cast chocolate, and uncover a surface 3 thereof to liquid agitated in tank 11. Support member 20 cooperates with spacer 28 on tank bottom 12. Spacer 28 is arranged to space body 2 above bottom 12. Spacer 28 acts as a thermal insulator or dampener to prevent direct exposure of body 2 to tank bottom 12 when heated.

1. A process for preparing a beverage comprising:
providing a liquid carrier;
supplying a flavoring ingredient to the liquid carrier; and
agitating the liquid carrier to promote dissolution and/or dispersion of the flavoring ingredient therein, the flavoring ingredient being supplied in the form of a self-sustaining body to the liquid carrier, the self-sustaining body having at least one surface from which the flavoring ingredient is dissolved and/or dispersed into the liquid carrier and the liquid carrier is automatically agitated in a controlled manner to circulate on the at least one surface so as to achieve a controlled dissolution and/or dispersion of the flavoring ingredient into the liquid carrier.

2. The process of claim 1, wherein the flavoring ingredient is dissolved and/or dispersed into the liquid carrier:
from over the entire at least one surface at a substantially uniform rate.

3. The process of claim 1, comprising providing a tank and preparing a batch of the beverage by dissolving and/or dispersing the flavoring ingredient into the liquid carrier that is contained in the tank.

4. The process of claim 3, wherein the tank is associated with a delivery member for delivering heat into the liquid carrier in a heat delivery zone.

5. The process of claim 4, wherein the self-sustaining body is held in the liquid carrier and spaced apart from the heat delivery zone.

6. The process of claim 3, comprising forming a vortex in the liquid carrier by controlled agitation of the liquid carrier and driving the liquid carrier therein.

7. The process of claim 6, wherein the self-sustaining body has a main surface from which the flavoring ingredient is predominantly dissolved and/or dispersed into the liquid carrier, the main surface being so located in the agitated liquid carrier to be exposed substantially everywhere thereto at a generally uniform relative velocity.

8. The process of claim 1, wherein:
the liquid carrier comprises at least one liquid selected from the group consisting of water, milk and coffee.

9. A process for preparing a chocolate-based beverage comprising:
providing a liquid carrier in a tank;
supplying chocolate into the liquid carrier;
heating the liquid carrier; and
agitating the liquid carrier to mix the chocolate and the liquid carrier, the tank is associated with a motorised impeller controlled by a control unit for controllably agitating the liquid carrier in the tank to mix substantially homogeneously the chocolate in the liquid carrier.

10. A beverage preparation device comprising:
a tank for containing a liquid carrier;
a motorised impeller for imparting a controlled agitation to the liquid carrier; and
a support for supporting and positioning a self-sustaining body of flavoring ingredient in the liquid carrier contained in the tank, the self-sustaining body having at least one surface from which the flavoring ingredient is dissolved and/or dispersed into the liquid carrier during the process, the motorised impeller and the support being so located in the tank that, during use, the liquid carrier is agitated by the impeller in a controlled manner to circulate on said at least one surface of the self-sustaining body to achieve a controlled dissolution and/or dispersion of the flavoring ingredient into the liquid carrier.

11. The device of claim 10, wherein the tank is associated with a delivery member for delivering heat into the liquid carrier in a heat delivery zone, the support being arranged so that the self-sustaining body is held in the liquid carrier and spaced apart from the heat delivery zone during the process.

12. The device of claim 10, wherein the impeller and the support are so arranged in the tank that the self-supporting body is held at a distance from the impeller.

13. The device of claim 12, wherein the tank has a general cylindrical or frusto-conical shape extending upright about a central axis of revolution, the motorised impeller being located off-axis in the tank and the support means being arranged to support and position the self-sustaining body diameterally opposite the impeller.

14. The device of claim 12, wherein the support is arranged to support the self-sustaining body with a main surface thereof from which the flavoring ingredient is predominantly dissolved and/or dispersed into the liquid carrier, the main surface being arched and extending generally around the impeller.

15. The device of claim 10, wherein the self-sustaining body has a main surface from which the flavoring ingredient is predominantly dissolved and/or dispersed into the liquid carrier, the main surface being so located in the agitated liquid carrier to be exposed substantially everywhere thereto at a generally uniform relative velocity.

16. The process of claim 1, wherein the flavoring ingredient is dissolved and/or dispersed into the liquid carrier:
from the at least one surface at a substantially constant rate over a predominant period of the dissolution and/or dispersion.

17. The process of claim 1 including heating the liquid carrier.

18. The process of claim 1, wherein the flavoring ingredient is selected from the group consisting of coffee, chocolate, cocoa, sugar and honey.

19. A beverage preparation device of claim 10 including a heater for heating the liquid carrier in the tank.
